(19) United States
(12) Patent Application Publication
(10) Pub. No.: US 2024/0328825 A1
(43) Pub. Date: Oct. 3, 2024

(54) GAS CONSUMPTION CORRECTION METHOD BASED ON TEMPERATURE DATA FOR GAS DATA PLATFORM

(71) Applicant: Korea Electronics Technology Institute, Seongnam-si (KR)

(72) Inventors: Seong Seop KIM, Yongin-si (KR); Young Min KWON, Seongnam-si (KR); Seung Woo LEE, Seongnam-si (KR); Min Su KIM, Seongnam-si (KR)

(73) Assignee: Korea Electronics Technology Institute, Seongnam-si (KR)

(21) Appl. No.: 18/621,826

(22) Filed: Mar. 29, 2024

(30) Foreign Application Priority Data
Mar. 31, 2023 (KR) 10-2023-0042952

(51) Int. Cl. G01D 4/00; G01D 4/02; G01D 21/02

(52) U.S. Cl. CPC G01D 4/004; G01D 4/02; G01D 21/02; G01D 2204/26

(57) ABSTRACT

There is provided a temperature data-based gas usage correction method for a gas data platform. According to an embodiment, an energy usage correction method may collect gas meter reading data, may calculate energy usage based on the gas meter reading data, may collect temperature data, and may correcting the calculated energy usage. Accordingly, when it is impossible to obtain temperature in reading a gas meter, temperature compensation may be performed by linking temperature data collected separately and gas usage, and gas usage may be more exactly measured by correcting gas usage by compensating for temperature variation caused by a difference in seasons, installation regions in a gas data platform.

### CROSS-REFERENCE TO RELATED APPLICATION(S) AND CLAIM OF PRIORITY

This application is based on and claims priority under 35 U.S.C. § 119 to Korean Patent Application No. 10-2023-0042952, filed on Mar. 31, 2023, in the Korean Intellectual Property Office, the disclosure of which is herein incorporated by reference in its entirety.

### BACKGROUND

### Field

The disclosure relates to a gas consumption correction technology, and more particularly, to a technology for correcting gas consumption through temperature compensation in an environment in which gas data is collected for a data platform based an advanced metering infrastructure (AMI).

### Description of Related Art

Gas has the property of changing its volume according to temperature and atmospheric pressure, and in real life, an influence by atmospheric pressure is insignificant but an influence by temperature is not negligible. Accordingly, a temperature influence should be compensated for to identify exact gas consumption.

To achieve this, temperature data is required. When a temperature sensor is provided in an AMI meter, there may be no problem since temperature data is obtained along with meter reading data.

A problem may arise when a temperature sensor is not provided in an AMI meter or when meter reading is performed by a consumer, not by an AMI. Accordingly, there is a need for a method for temperature compensation even in such a case.

### SUMMARY

The disclosure has been developed in order to solve the above-described problems, and an object of the disclosure is to provide, as a solution for measuring gas consumption more exactly, a method for compensating for a temperature influence by linking temperature data collected separately and energy usage.

To achieve the above-described object, an energy usage measurement method according to an embodiment of the disclosure may include: collecting gas meter reading data; calculating energy usage based on the gas meter reading data; collecting temperature data; and correcting the calculated energy usage, based on the collected temperature data.

Correcting may include: calculating an average temperature of the collected temperature data; and correcting the energy usage based on the calculated average temperature.

The gas meter reading data may be collected from an AMI meter, the temperature data may be temperature data of a region where the AMI meter is installed, and correcting may include correcting each energy usage indicated by each gas meter reading data collected, based on an average temperature of a corresponding time period of each gas meter reading data.

A temperature data collection period may be shorter than a gas meter reading data collection period. The gas meter reading data may be collected by self-meter reading by a consumer, and the temperature data may be temperature data of a region of a consumer residence.

Correcting may include correcting gas energy usage, based on an average temperature which is calculated from temperature data collected from a previous gas meter reading data collection time to a present gas meter reading data collection time.

Correcting may include, when a consumer uses a gas boiler, calculating the average temperature by giving a variable weight to daytime temperature data and nighttime temperature data.

Correcting may include, when a consumer does not use a gas boiler, calculating the average temperature by invariably giving a higher weight to daytime temperature data than nighttime temperature data.

Correcting may include: giving a higher weight to daytime temperature data than nighttime temperature data in the summer; and giving a higher weight to nighttime temperature data than daytime temperature data in the winter.

According to another embodiment of the disclosure, an energy usage measurement system may include: a gas data platform configured to collect gas meter reading data, and to calculate energy usage based on the gas meter reading data; and a data correction server configured to collect temperature data, and to correct energy usage of the gas data platform, based on the collected temperature data.

According to still another embodiment of the disclosure, an energy usage correction method may include: collecting temperature data from a weather server; and correcting energy usage, based on the collected temperature data.

According to yet another embodiment of the disclosure, an energy usage correction server may include: a communication unit configured to communicate with a weather server and a gas data platform; and a processor configured to collect temperature data from the weather server, and to correct energy usage of the gas data platform, based on the collected temperature data.

As described above, according to embodiments of the disclosure, when it is impossible to obtain temperature in reading a gas meter, temperature compensation may be performed by linking temperature data collected separately and gas usage, and gas usage may be more exactly measured by correcting gas usage by compensating for temperature variation caused by a difference in seasons, installation regions in a gas data platform.

Other aspects, advantages, and salient features of the invention will become apparent to those skilled in the art from the following detailed description, which, taken in conjunction with the annexed drawings, discloses exemplary embodiments of the invention.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a view illustrating a gas AMI system according to an embodiment of the disclosure;

FIGS. 2 and 3 are views provided to explain an AMI data-based gas usage correction method;

FIG. 4 is a view provided to explain a self-meter-reading-based gas usage correction method; and

FIG. 5 is a view illustrating a configuration of a data correction server shown in FIG. 1.

### DETAILED DESCRIPTION

Hereinafter, the disclosure will be described in more detail with reference to the accompanying drawings.

Embodiments of the disclosure provide a temperature data-based gas usage correction method for a gas data platform. The disclosure relates to a technology for measuring exact gas usage by correcting gas usage through temperature compensation by linking gas data collected through a gas data platform and temperature data separately collected.

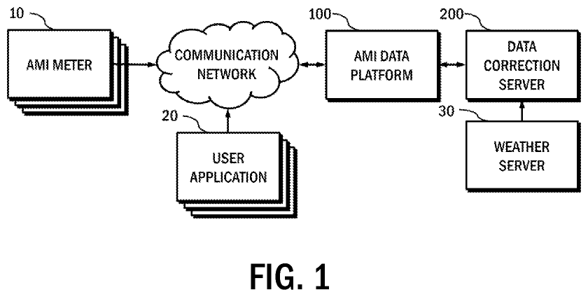

FIG. 1 is a view illustrating gas advanced metering infrastructure (AMI) system according to an embodiment of the disclosure. As shown in FIG. 1, the gas AMI system according to an embodiment of the disclosure may include AMI meters 10, user applications 20, a weather server 30, an AMI data platform 100, and a data correction server 200.

The AMI meters 10 may generate gas AMI data (gas meter reading data) and may periodically transmit the gas AMI data to the AMI data platform 100 through a communication network. The AMI meters 10 may not be provided with a temperature sensor.

The user applications 20 refer to applications that receive gas meter reading data from consumers who use self-meter reading services, and transmit the gas meter reading data to the AMI data platform 100, or user terminals exeucting these applications.

The weather server 30 is a server that provides weather information, and may include a server of a weather center, a portal server, or a server of a regional weather observation station.

The AMI data platform 100 may collect/store gas AMI data which is transmitted from the AMI meters 10 and self-meter reading data which is received from the user applications 20, and may preserve the data.

In addition, the AMI data platform 100 may calculate gas usage of each household from the collected meter reading data, and may store/preserve the calculated gas usage along with collected meter reading data. Gas usage data preserved by the AMI data platform 100 may be provided to a gas supplier and may be used as a basis for charging.

The data correction server 200 may correct gas usage preserved in the AMI data platform 100 through temperature compensation. The AMI data platform 100 may preserve exact gas usage due to the data correction server 200.

For temperature compensation, the data correction server 200 may periodically collect temperature data from the weather server 30. Temperature data to be collected may include temperature data of a region where the AMI meters 10 are installed, and temperature data of a region where self-meter reading households are located.

A temperature data collection period of the data correction server 200 may be shorter than not only a self-meter reading period but also a gas AMI data collection period of the AMI data platform 100.

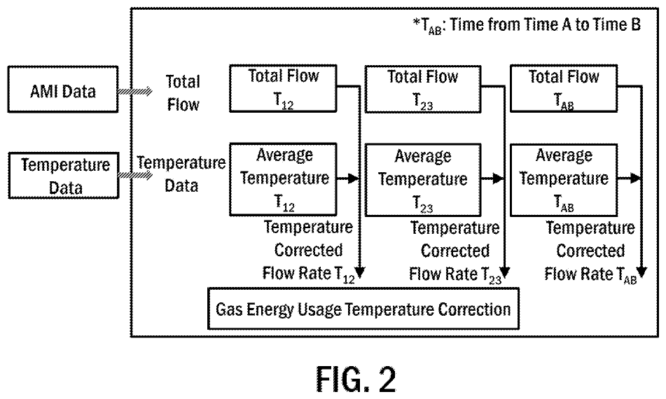

Hereinafter, an AMI gas data-based gas usage correction method by the data correction server 200 will be described in detail with reference to FIG. 2. FIG. 2 is a view provided to explain a gas usage correction method according to another embodiment of the disclosure.

As shown in the upper part of FIG. 2, AMI data that is generated at the AMI meters 10 and stored in the AMI data platform 100 may include gas flow rate data which is used in a household, and flow rate data indicates gas usage.

In order to calculate gas usage in a charging period, flow rate data should be integrated. Since AMI data is periodically generated at regular intervals, flow rate data may correspond to a total flow accumulated during a predetermined time period (TAB: a time period from time A to time B).

Temperature compensation may be required prior to integrating total flows included in a charging period, and, as shown in the middle part of FIG. 2, an average temperature in each time period of each total flow may be calculated. The average temperature may be calculated by averaging temperature data collected in a corresponding time period.

As described above, a temperature data collection period is shorter than a gas AMI data collection period, and thus, it is possible to calculate an average temperature according to time periods of flow rate data.

Gas usage may be corrected by performing volume compensation with respect to each total flow of each time period according to an average temperature of the corresponding time period. Gas usage may be corrected through temperature compensation according to the following equation:

$$Qs = Qa \times Ft$$

Here, Qs is a volume flow rate of gas at standard temperature, pressure, Qa is a measured gas flow rate, and Ft is a temperature correction coefficient. The temperature correction coefficient Ft may be determined according to the following equation:

$$Ft = Ts / Ta$$

Here, Ts is a standard temperature (expressed by an absolute temperature), and Ta is a temperature (a temperature of gas measured in a measurement state, an absolute temperature).

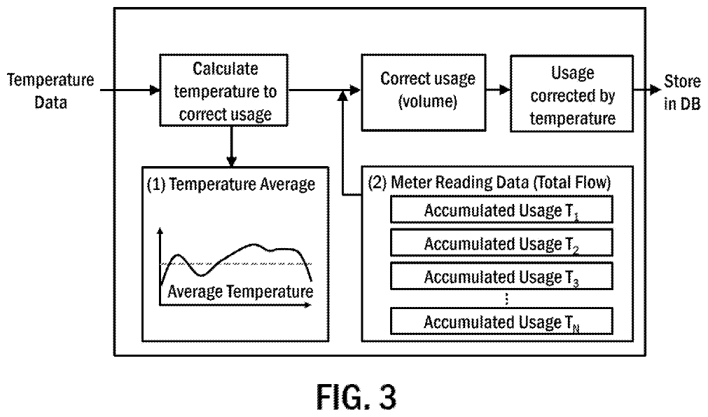

Hereinafter, another method for correcting gas usage based on AMI gas data by the data correction server 200 will be described in detail with reference to FIG. 3. FIG. 3 is a view provided to explain a gas usage correction method according to still another embodiment of the disclosure.

In the gas usage correction method proposed in FIG. 3, an average temperature may be equally applied to total flows. That is, in this method, gas usage may be corrected by performing volume compensation with respect to all of total flows with an average temperature which is an average of temperature data collected in an entire charging period. Gas usage correction through temperature compensation may be performed according to the equation described above.

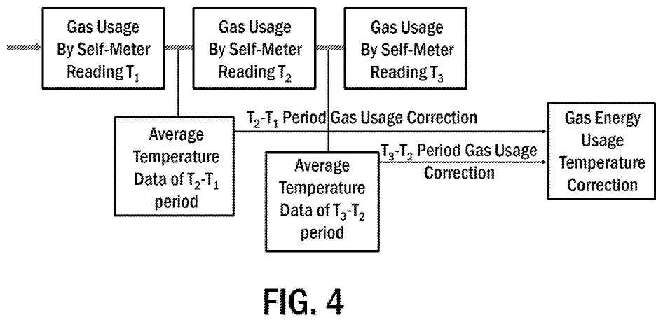

Hereinafter, a method for correcting gas usage which is read by a household in which an AMI meter 10 is not installed will be described in detail with reference to FIG. 4. FIG. 4 is a view provided to explain a gas usage correction method according to yet another embodiment.

In the case of a household in which an AMI meter 10 is not installed, gas usage may be calculated through self-meter reading by a consumer. In the case of self-meter reading, a consumer may input a result of meter reading through a user application 20 every meter reading period, and the inputted meter reading result may be transmitted to the AMI data platform 100 and stored therein.

Gas usage of a meter reading period may be calculated by subtracting previous meter reading data from a result of meter reading, strictly, present meter reading data. To correct the gas usage, the data correction server 200 may calculate an average temperature during a meter reading period. The average temperature calculated is an average value of temperature data which has been collected during the meter reading period, that is, temperature data which has been collected from a previous gas meter reading data collection time to a present gas meter reading data collection time.

The data correction server 200 may correct gas usage by performing volume compensation with respect to gas usage read by the consumer according to the calculated average temperature. Gas usage correction through temperature compensation may be performed according to the above-described equation.

When an average temperature in an entire meter reading period is used as a reference value for temperature compensation, accuracy of measurement of gas usage may be degraded. Accordingly, resolutions for solving this are proposed as follows.

First, when a consumer uses a gas boiler, a variable weight may be given to daytime temperature data and nighttime temperature data in calculating an average temperature.

Specifically, in the summer, a higher weight may be given to daytime temperature data than nighttime temperature data, and in the winter, a higher weight may be given to nighttime temperature data than daytime temperature data. For example, in the winter, a weight of 0.5 may be given to daytime temperature data, and a weight of 1.5 may be given to nighttime temperature data. This reflects that gas is mostly used during the nighttime since a large amount of gas is used by a gas boiler in the winter.

On the other hand, when a consumer does not use a gas boiler, a higher weight may be invariably given to daytime temperature data than nighttime temperature data in calculating an average temperature. For example, a weight of 1.2 may be given to daytime temperature data, and a weight of 0.8 may be given to nighttime temperature data. In the case of a household without a gas boiler, most of gas may be used through a gas range and cooking using a gas range may be performed more frequently in the daytime than the nighttime.

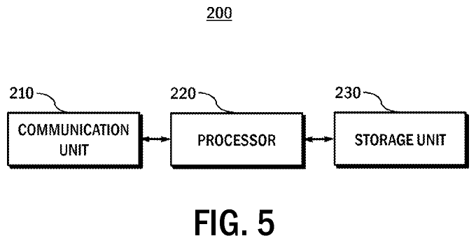

FIG. 5 is a view illustrating a configuration of the data correction server 200 shown in FIG. 1. The data correction server 200 may include a communication unit 210, a processor 220, and a storage unit 230 as shown in FIG. 5.

The communication unit 210 is a communication means for exchanging data with the weather server 30 and the AMI data platform 100.

The processor 220 may correct gas usage that is preserved in the AMI data platform 100 according to the methods proposed in FIGS. 2 to 4.

The storage unit 230 is a storage that provides a storage space necessary for the processor 220 to operate and function.

Up to now, a temperature data-based gas usage correction method for a gas data platform has been described in detail with reference to preferred embodiments.

The above embodiments provide a method for correcting gas usage by linking temperature data to measure exact gas usage. Through the temperature-based gas usage correction method, a gas usage volume may be corrected in a gas data platform according to a season, an installation environment, so that more exact gas energy usage may be measured.

Gas suggested in the above embodiments is merely an example of energy. The technical concept of the disclosure is applicable to other energy than gas.

The technical concept of the disclosure may be applied to a computer-readable recording medium which records a computer program for performing the functions of the apparatus and the method according to the present embodiments. In addition, the technical idea according to various embodiments of the disclosure may be implemented in the form of a computer readable code recorded on the computer-readable recording medium. The computer-readable recording medium may be any data storage device that can be read by a computer and can store data. For example, the computer-readable recording medium may be a read only memory (ROM), a random access memory (RAM), a CD-ROM, a magnetic tape, a floppy disk, an optical disk, a hard disk drive, or the like. A computer readable code or program that is stored in the computer readable recording medium may be transmitted via a network connected between computers.

In addition, while preferred embodiments of the present disclosure have been illustrated and described, the present disclosure is not limited to the above-described specific embodiments. Various changes can be made by a person skilled in the at without departing from the scope of the present disclosure claimed in claims, and also, changed embodiments should not be understood as being separate from the technical idea or prospect of the present disclosure.

What is claimed is:

1. An energy usage measurement method comprising:
collecting gas meter reading data;
calculating energy usage based on the gas meter reading data;
collecting temperature data; and
correcting the calculated energy usage, based on the collected temperature data.

2. The energy usage measurement method of claim 1, wherein correcting comprises:
calculating an average temperature of the collected temperature data; and
correcting the energy usage based on the calculated average temperature.

3. The energy usage measurement method of claim 1, wherein the gas meter reading data is collected from an AMI meter,
wherein the temperature data is temperature data of a region where the AMI meter is installed, and
wherein correcting comprises correcting each energy usage indicated by each gas meter reading data collected, based on an average temperature of a corresponding time period of each gas meter reading data.

4. The energy usage measurement method of claim 3, wherein a temperature data collection period is shorter than a gas meter reading data collection period.

5. The energy usage measurement method of claim 1, wherein the gas meter reading data is collected by self-meter reading by a consumer, and
wherein the temperature data is temperature data of a region of a consumer residence.

6. The energy usage measurement method of claim 5, wherein correcting comprises correcting gas energy usage, based on an average temperature which is calculated from temperature data collected from a previous gas meter reading data collection time to a present gas meter reading data collection time.

7. The energy usage measurement method of claim 6, wherein correcting comprises, when a consumer uses a gas boiler, calculating the average temperature by giving a variable weight to daytime temperature data and nighttime temperature data.

8. The energy usage measurement method of claim 7, wherein correcting comprises, when a consumer does not use a gas boiler, calculating the average temperature by invariably giving a higher weight to daytime temperature data than nighttime temperature data.

9. The energy usage measurement method of claim 7, wherein correcting comprises:
giving a higher weight to daytime temperature data than nighttime temperature data in the summer; and
giving a higher weight to nighttime temperature data than daytime temperature data in the winter.

10. An energy usage measurement system comprising:
a gas data platform configured to collect gas meter reading data, and to calculate energy usage based on the gas meter reading data; and
a data correction server configured to collect temperature data, and to correct energy usage of the gas data platform, based on the collected temperature data.

11. An energy usage correction method comprising:
collecting temperature data from a weather server; and
correcting energy usage, based on the collected temperature data.
